(19) United States
(12) Patent Application Publication
(10) Pub. No.: US 2024/0067551 A1
(43) Pub. Date: Feb. 29, 2024

(54) WATER TREATING DEVICE AND WET CLEANING DEVICE INCLUDING THE SAME

(71) Applicant: SAMSUNG ELECTRONICS CO., LTD., Suwon-si Gyeonggi-do (KR)

(72) Inventors: David Kim, Suwon-si (KR); Seoktae Kang, Daejeon (KR); Seunghyun Lee, Suwon-si (KR); Donghoon Choi, Suwon-si (KR); Junho Kim, Daejeon (KR); Daeseon Park, Daejeon (KR)

(73) Assignee: Korea Advanced Institute of Science and Technology, Daejeon (KR)

(21) Appl. No.: 18/451,941

(22) Filed: Aug. 18, 2023

(30) Foreign Application Priority Data
Aug. 29, 2022 (KR) 10-2022-0108655

(51) Int. Cl. C02F 9/00; B01D 47/06

(52) U.S. Cl. CPC C02F 9/00; B01D 47/06; C02F 1/004

(57) ABSTRACT

Embodiments of the present inventive concept provides a water treating device for treating a circulating water including a storage tank configured to store the circulating water, a first filter configured to filter the circulating water discharged by the storage tank, a phosphorus removing device configured to remove phosphorus contained in the circulating water, and an ultraviolet ray irradiation device configured to irradiate an ultraviolet ray to the circulating water.

### CROSS-REFERENCE TO RELATED APPLICATION

This U.S. non-provisional patent application claims priority under 35 U.S.C. § 119 to Korean Patent Application No. 10-2022-0108655, filed on Aug. 29, 2022 in the Korean Intellectual Property Office, the disclosure of which is incorporated by reference herein in its entirety.

### TECHNICAL FIELD

Embodiments of the present inventive concept relate to a water treating device and a wet cleaning device including the water treating device. More specifically, embodiments of the present inventive concept relate to a water treating device including a removal device and a wet cleaning device including the water treating device.

### DISCUSSION OF RELATED ART

Typically, air includes unwanted contaminates which may, as a result, reduce the yield of a semiconductor manufacturing process. Accordingly, a high-purity gaseous environment is required in a semiconductor manufacturing facility. To meet this requirement, semiconductors are manufactured in a clean room, in which the high-purity gaseous environment is maintained. On the other hand, various filters, a water showering system (WSS), and similar systems are used to supply high-purity air into the clean room. Among the various systems, the WSS is a facility, which removes water-soluble contaminants in the air using a gas-liquid contact method by spraying water into the external air. In the WSS, deionized water is used to remove the water-soluble contaminants, and some of the deionized water used in the WSS is recovered and supplied back to the WSS by using a purification process.

### SUMMARY

Embodiments of the inventive concept provide a water treating device including a phosphorus removal device and a wet cleaning device including the water treating device.

According to embodiments of the inventive concept, a water treating device for treating a circulating water is described, where the water treating device comprises: a storage tank configured to store the circulating water; a first filter configured to filter the circulating water discharged by the storage tank; a phosphorus removing device configured to remove phosphorus contained in the circulating water; and an ultraviolet ray irradiation device configured to irradiate an ultraviolet ray to the circulating water.

According to embodiments of the inventive concept, a wet cleaning device comprises: a spray device configured to spray a process water into air; a removing device configured to drop the process water and a circulating water containing contaminants collected by the process water; and a water treating device configured treat the circulating water to obtain a treated process water, and to supply the treated process water to the spray device. The water treating device comprises a storage tank configured to store the circulating water; a first filter configured to filter the circulating water discharged by the storage tank; a phosphorus removing device configured to remove phosphorus contained in the circulating water; and an ultraviolet ray irradiation device configured to irradiate an ultraviolet ray to the circulating water.

According to embodiments of the inventive concept, a water treating device for treating circulating water is described, where the water treating device comprises: a storage tank configured to store a first circulating water; a supply tank configured to supply a supplementing water to the storage tank; a first filter configured to filter the first circulating water and a second circulating water, where the second circulating water includes the supplementing water; a phosphorus removing device configured to remove phosphorus contained in the second circulating water; and an ultraviolet ray irradiation device configured to irradiate an ultraviolet ray to the second circulating water, where the phosphorus removing device comprises a phosphorus absorbent, an ion exchange resin, an electrodialysis device, and/or an electrodeionization (EDI) device.

### BRIEF DESCRIPTION OF THE DRAWINGS

FIG. 1 is a block diagram of an outdoor air conditioner according to an embodiment.

FIG. 2 is a schematic block diagram of a water treating device according to an embodiment.

FIG. 3 is a graph of the volume of a microbial layer generated per unit area of a removing device based on whether a phosphorus removal device is included.

FIG. 4 is a diagram of confocal laser scanning microscope (CLSM) images of a wet cleaning device.

FIGS. 5A, 5B, and 5C are schematic cross-sectional views of water treating devices according to embodiments of the present inventive concept.

### DETAILED DESCRIPTION OF THE EMBODIMENTS

Hereinafter, embodiments of the inventive concept are described in detail with reference to the accompanying drawings. Identical reference numerals are used for the same constituent elements in the drawings, and duplicate descriptions thereof may be omitted.

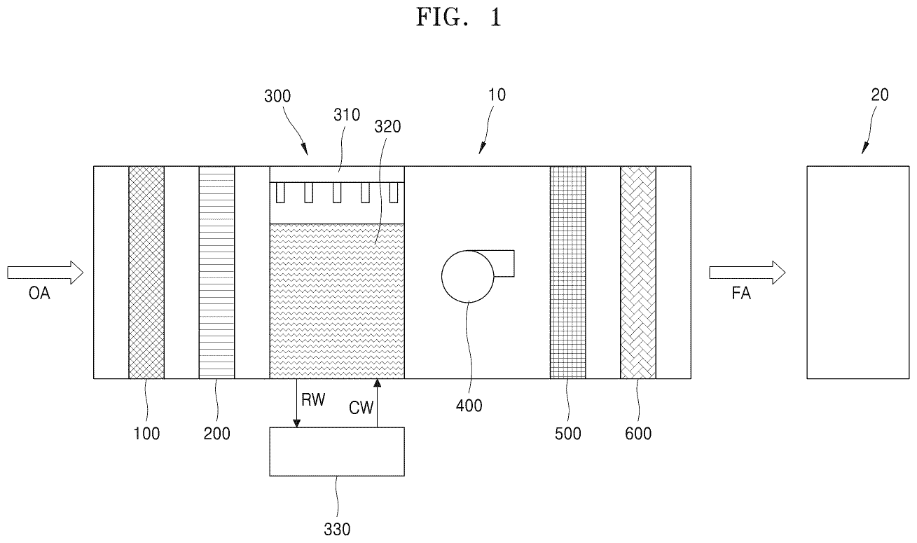

FIG. 1 is a block diagram of an outdoor air conditioner 10 according to an embodiment.

Referring to FIG. 1, the outdoor air conditioner 10 may include a first air filter 100, a temperature control device 200, a wet cleaning device 300, a fan 400, a chemical filter 500, and a second air filter 600. The outdoor air conditioner 10 may include, for example, an out air handling unit (OAHU) for supplying clean air FA into a clean room 20.

According to some embodiments, the first air filter 100 may filter an outdoor air OA supplied from the outside to the outdoor air conditioner 10, and remove dust, mote, or similar substances included in the outdoor air OA. The first air filter 100 may include, for example, a pre-filter, but is not limited thereto. In an embodiment, the outdoor air conditioner 10 may include a plurality of first air filters 100. For example, the outdoor air conditioner 10 may include two first air filters, one of the two first air filters may include the pre-filter, and the other of the two first air filters may include a medium-filter. In this case, the pre-filter may include a filter having a minimum efficiency reporting value (MERV) rating of about 3 to about 9 (e.g., which filters particle size of 3-10 microns), and the medium-filter may include a filter having a minimum efficiency reporting value rating of about 10 to about 14 (e.g., which filters particle size of 1-3 microns).

The temperature control device 200 may adjust the temperature of the outdoor air OA treated by the first air filter 100. The temperature control device 200 may include, for example, a cooling coil and a heating coil. The temperature of the outdoor air OA may be adjusted according to various process conditions by the temperature control device 200.

The wet cleaning device 300 may remove water-soluble contaminants from the outdoor air OA treated by the temperature control device 200 using a gas-liquid contact method. The water-soluble contaminants may include, for example, water-soluble gases, such as NH₃, NOₓ, and SOₓ, organic materials, etc. The wet cleaning device 300 may include, for example, a water showering system (WSS), which treats the air supplied to the clean room, but is not limited thereto.

The wet cleaning device 300 may include a spray device 310, a removing device 320, and a water treating device 330. In an embodiment, the spray device 310 is configured to spray process water to the outdoor air OA. In an embodiment, the removing device 320 is configured to drop down the process water and circulation water containing water-soluble contaminants collected by the process water. In some cases, circulation water may be the same as circulating water RW. In an embodiment, the water treating device 330 is configured to generate treated process water CW by treating circulating water RW having passed through the removing device 320. In some embodiments, the treated process water CW is supplied to the spray device 310.

The spray device 310 may spray the process water to the outdoor air OA. The process water may include, for example, general water, such as tap water and industrial water, or deionized water. The water-soluble contaminants contained in the outdoor air OA may be in gas-liquid contact with the process water sprayed onto the outdoor air OA, and may be collected by the process water. In an embodiment, the spray device 310 may include a plurality of nozzles. In some embodiments, pressure or ultrasonic waves are applied to the plurality of nozzles, where the process water may be continuously and/or continually sprayed in droplets of fine sizes from the plurality of nozzles.

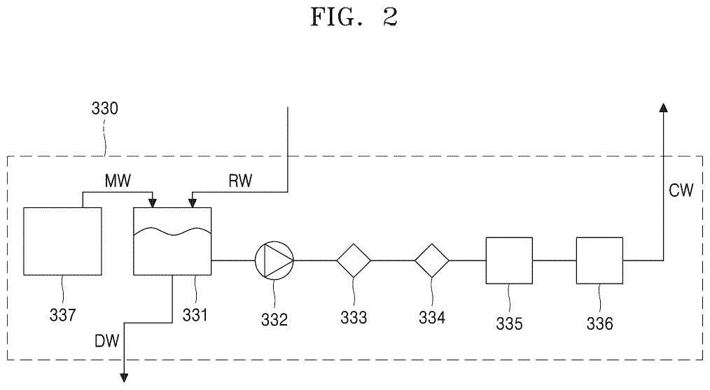

The removing device 320 may be disposed below the spray device 310. The removing device 320 may be in contact with the circulating water RW in the form of fine droplets falling down, and may collect water-soluble contaminants contained in the circulating water RW. The circulating water RW may collide (e.g., from free fall) with the removing device 320 and fall down, and the circulating water RW passing through the removing device 320 may be stored in a storage tank (e.g., storage tank 331 in FIG. 2) of the water treating device 330. The removing device 320 may include, for example, a plurality of porous plates. In some cases, the plurality of porous plates may include material made of plastic, fiber, stainless steel, or a combination thereof.

The water treating device 330 may store the circulating water RW falling from the removing device 320, generate the treated process water CW by treating the circulating water RW stored in the removing device 320, and supply the treated process water CW to the spray device 310. Further detailed descriptions regarding the water treating device 330 are described with reference to FIG. 2.

The fan 400 may move the outdoor air OA treated by the wet cleaning device 300 toward the chemical filter 500. In some embodiments, the outdoor air conditioner 10 may further include a temperature controller and a humidity controller between the wet cleaning device 300 and the fan 400. The temperature controller and the humidity controller may adjust the temperature and humidity, respectively, of the outdoor air OA treated by the wet cleaning device 300.

The chemical filter 500 may remove organic materials, residual NH₃, ozone O₃, and similar substances contained in the outdoor air OA moved by the fan 400. The chemical filter 500 may include, for example, an ion exchange filter, an activated carbon fiber filter, an activated carbon pellet filter, or similar filters, but is not limited thereto. In some embodiments, the outdoor air conditioner 10 includes one or more chemical filters.

The second air filter 600 may remove dust, mote, or similar substances contained in the outdoor air OA treated by the chemical filter 500. The second air filter 600 may include a filter having a greater minimum efficiency reporting value (MERV) than the first air filter 100. For example, the second air filter 600 may include a high efficiency particulate air (HEPA)-filter or an ultra-low penetration air (ULPA)-filter. In some cases, the second air filter 600 is a filter having a higher MERV than the first air filter 100, dust, mote, or similar substances which has not been removed by the first air filter 100 may be removed by the second air filter 600. The outdoor air OA treated by the second air filter 600 may be converted to a clean air FA and may be supplied to the clean room 20, in which a semiconductor manufacturing process is performed. The clean room 20 may include a space, in which various types of semiconductor manufacturing processes are performed. For example, the clean room 20 may include a space, in which a photo-lithography process is performed during the semiconductor manufacturing process.

FIG. 2 is a schematic block diagram of the water treating device 330 according to an embodiment.

Referring to FIG. 2, the water treating device 330 may include a storage tank 331, a pump 332, a first filter 333, a second filter 334, a phosphorus removing device 335, an ultraviolet ray irradiation device 336, and a supply tank 337.

The storage tank 331 may be configured to store the circulating water RW from the removing device 320. In some cases, a portion of the circulating water RW stored in the storage tank 331 may be discharged from a drain as discharge water DW. Additionally, supplementing water MW may be supplied from the supply tank 337 to the storage tank 331 to supplement the amount of the circulating water RW vaporized in the wet cleaning device (e.g., wet cleaning device 300 in FIG. 1).

As used herein, the term “downstream” refers to the connection of two components such that water flows from the first component to the second component. The pump 332 may be downstream of the storage tank 331. For example, water flows from storage tank 331 to pump 332. The pump 332 may pump the circulating water RW stored in the storage tank 331 to the first filter 333, and the amount of the circulating water RW moved to the first filter 333 may be adjusted by the pump 332. In some cases, the pump 332 controls the flow rate of the circulating water RW. In an embodiment, the pump 332 may pump the circulating water RW and the supplementing water MW stored in the storage tank 331 t the first filter.

The first filter 333 may be downstream of the pump 332. The first filter 333 may remove slurry, micro-organisms, or similar substances included in the circulating water RW. The first filter 333 may include, for example, a micro-filter including pores with a diameter of about 20 μm, but is not limited thereto.

The second filter 334 may be downstream of the first filter 333. The second filter 334 may remove micro-organisms or similar substances in the circulating water RW, which have not been removed by the first filter 333. The second filter 334 may include, for example, a micro-filter including pores with a diameter of about 0.1 μm to about 2 μm, or pores with a diameter of about 0.1 μm to about 1 μm, but is not limited thereto. For example, pores of the second filter 334 is smaller than the pores of the first filter. In an embodiment, second filter 334 might not be included in water treating device 330.

The phosphorus removing device 335 may be downstream of the first filter 333 and the second filter 334. The phosphorus removing device 335 may be configured to remove phosphorus in the circulating water RW. Removal of phosphorus may prevent the growth of micro-organisms in the circulating water RW. Accordingly, the formation of a microbial layer by the micro-organisms may be prevented in the spray device 310 and the removing device 320 described with reference to FIG. 1.

In an embodiment, the phosphorus removing device 335 may include a phosphorus absorbent, an ion exchange resin, an electrodialysis device, an electrodeionization (EDI) device, or a combination thereof. For example, the phosphorus removing device 335 may include an electrodeionization device.

In an embodiment, the phosphorus removing device 335 may remove phosphorus in the circulating water RW. For example, the phosphorus concentration in the circulating water RW may be reduced to about 2 μg/L or less.

The ultraviolet ray irradiation device 336 may be downstream of the phosphorus removing device 335. The ultraviolet ray irradiation device 336 may be configured to irradiate ultraviolet rays to disinfect the circulating water RW having passed through the phosphorus removing device 335. The ultraviolet ray irradiation device 336 may include a plurality of ultraviolet ray lamps. In some cases, the ultraviolet ray irradiation device 336 may irradiate ultraviolet rays having a wavelength of about 185 nm and/or about 245 nm, but is not limited thereto.

In an embodiment, the supply tank 337 may be configured to supply the supplementing water MW to the storage tank 331. The storage tank 331 may supply supplementing water MW that is equal to the amount of vaporized circulating water RW to the storage tank 331.

In an embodiment, the water treating device 330 may further include a sensor configured to measure phosphorus concentration in the circulating water RW. In some cases, the water treating device 330 includes a plurality of sensors, but is not limited thereto.

The circulating water RW may be sequentially treated by the first filter 333, the second filter 334, the phosphorus removing device 335, and the ultraviolet ray irradiation device 336 to form the treated process water CW. The treated process water CW may be supplied back to the spray device 310 of the wet cleaning device (e.g., wet cleaning device 300 in FIG. 1) to be used for air cleaning in the wet cleaning device 300.

In a wet cleaning device for cleaning air supplied to a clean room, a microbial layer may be generated in the wet cleaning device due to micro-organisms in the process water used in the wet cleaning device. The microbial layer may block a process water spray device in the wet cleaning device and contaminate a removing device in the wet cleaning device. Therefore, the efficiency of reducing water-soluble contaminants collected in the process water may be reduced.

Conventional wet cleaning device removes the microbial layer generated in the wet cleaning device by using ultraviolet rays or removes the microbial layer by using a chemical disinfectant. However, in the case of the removing the microbial layer by using the ultraviolet rays, only the microbial layer in a local area, on which the ultraviolet rays are irradiated, is removed. Alternatively, in the case of removing the microbial layer by using a chemical disinfectant, the resistance of the micro-organism against the chemical disinfectant increases, and the outdoor air treated by the wet cleaning device has a high possibility of becoming contaminated due to the high volatility of a disinfection by-product (DBP) caused by oxidation of the micro-organism from the chemical disinfectant.

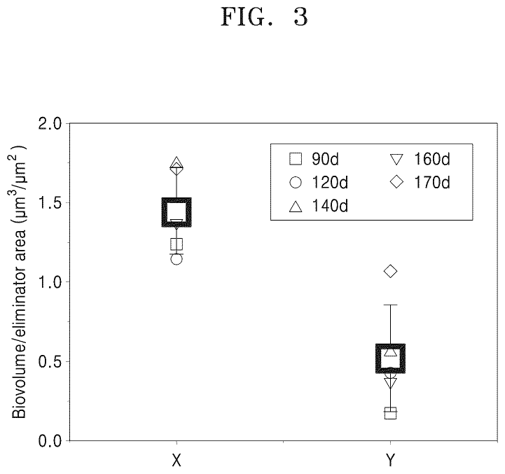

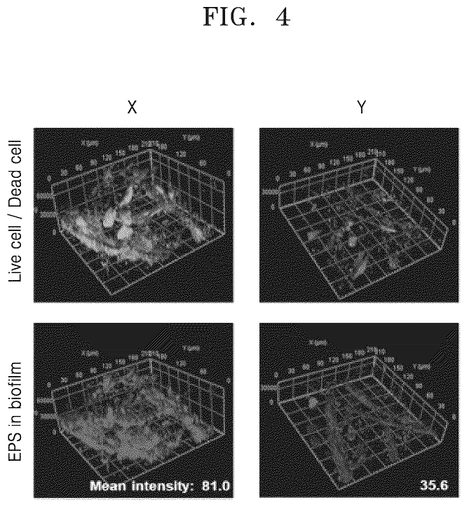

According to embodiments of the present inventive concept, the water treating device 330 includes the phosphorus removing device 335, where the phosphorus removing device 335 removes phosphorus in the circulating water RW in the water treating device 330. Accordingly, the growth of micro-organisms in the circulating water RW may be prevented, and the growth of micro-organisms in the treated process water CW obtained from the circulating water RW using the water treating device 330 may be prevented. Thus, an occurrence of the microbial layer in the spray device 310 and the removing device 320 may be prevented. Accordingly, clogging phenomenon of the spray device 310 and contamination of the removing device 320 may be prevented, the efficiency of removing water-soluble contaminants in the outdoor air OA may be increased, and the cost of removing the microbial layer generated in the wet cleaning device 300 may be reduced. In addition, embodiments of the present inventive concept prevent the generation of the microbial layer (e.g., embodiments of the present inventive concept is not to remove microbial layer), the possibility of contamination of the outdoor air OA can be reduced without changing operating conditions of the wet cleaning device 300. Hereinafter, the effect of the water treating device 330 according to embodiments of the present inventive concept is described in more detail with reference to FIGS. 3 and 4.

FIG. 3 is a graph of the volume of the microbial layer generated per unit area of the removing device 320 based on whether the phosphorus removing device 335 is included. The horizontal axis in FIG. 3 represents two water treating devices. For example, X may represent the water treating device 330 that does not include the phosphorus removing device 335, and Y may represent the water treating device 330 that includes the phosphorus removing device 335. The vertical axis in FIG. 3 represents volumes of the microbial layer generated in the removing device 320 per unit area thereof. The data is measured when the wet cleaning device 300 has been used for fixed time periods (e.g., 90 days, 120 days, 140 days, 160 days, and 170 days). In FIG. 3, “90d” (with a square symbol) may indicate the case of 90 days after the wet cleaning device 300 is used, “120d” (with a circle symbol) may indicate the case of 120 days after the wet cleaning device 300 is used, “140d” (with a triangle symbol) may indicate the case of 140 days after the wet cleaning device 300 is used, “160d” (with an upside down triangle symbol) may indicate the case of 160 days after the wet cleaning device 300 is used, and “170d” (with a diamond symbol) may indicate the case of 170 days after the wet cleaning device 300 is used. The data is obtained using the water treating device 330 that includes anion exchange resin as the phosphorus removing device 335. For example, the phosphorus removing device 335 is disposed between a rear end of the first filter 333 and a front end of the ultraviolet ray irradiation device 336.

As illustrated in FIG. 3, the volume of the microbial layer generated in the removing device 320 per unit area using the water treating device 330 including the phosphorus removing device 335, (i.e., Y) is less than the volume of the microbial layer generated in the removing device 320 using the water treating device 330 that does not include the phosphorus removing device 335 (i.e., X). As illustrated in the graph, when the phosphorus removing device 335 is included in the wet cleaning device 300, the formation of the microbial layer in the removing device 320 may be reduced.

FIG. 4 is a diagram of confocal laser scanning microscope (CLSM) images of the wet cleaning device 300. X may show images of distributions of live cells/dead cells (shown in upper left corner) and extracellular polymetric substances (EPS) (shown in lower left corner) existing in the wet cleaning device 300, where the water treating device 330 does not include the phosphorus removing device 335. Y may show images of distributions of live cells/dead cells (upper right corner) and extracellular polymetric substances (EPS) (lower right corner) existing in the wet cleaning device 300, where the water treating device 330 includes the phosphorus removing device 335. In some cases, the water treating device 330 includes anion exchange resin as the phosphorus removing device 335. For example, the phosphorus removing device 335 is disposed between the rear end of the first filter 333 and the front end of the ultraviolet ray irradiation device 336.

Referring to FIG. 4, compared to X, in which the water treating device 330 does not include the phosphorus removing device 335, the EPS of the live cells and the microbial layers distributed in the wet cleaning device 300 is less in the water treating device 330 includes the phosphorus removing device 335 (i.e., shown in Y). The degree of live cell distribution and the degree of EPS distribution of micro-organisms are indicators of the presence of microorganisms forming the microbial layer in the wet cleaning device 300. As illustrated in FIG. 4, when the phosphorus removing device 335 is included in the wet cleaning device 300, the formation of the micro-organisms in the circulating water RW and the formation of the microbial layer in the wet cleaning device 300 are suppressed.

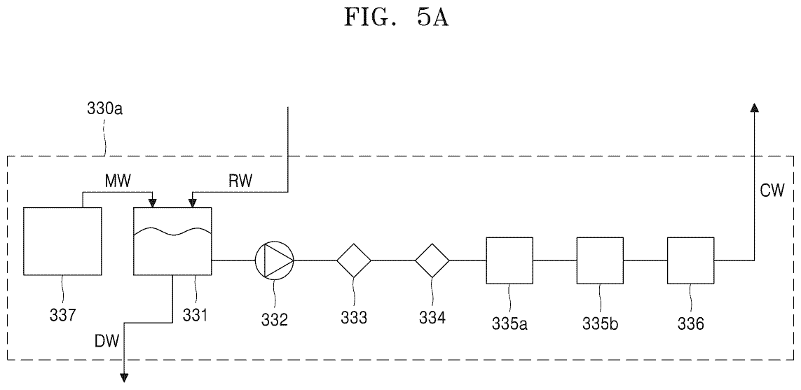

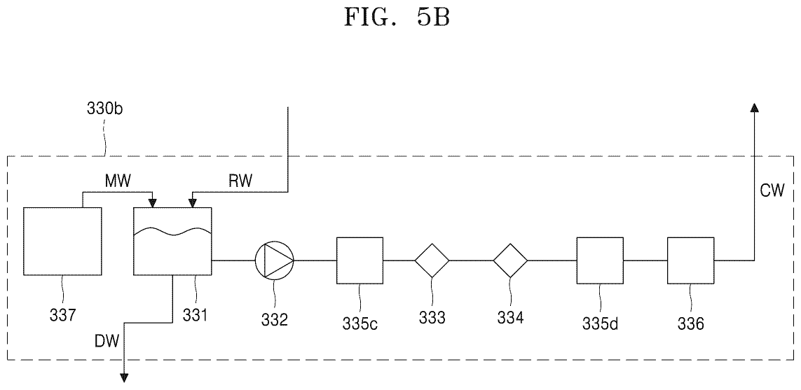

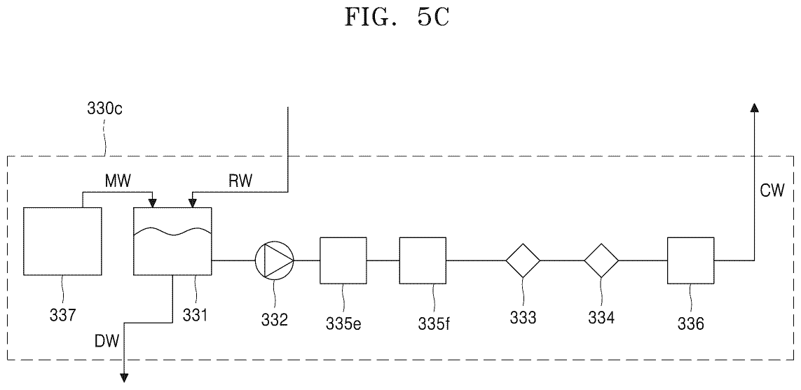

FIGS. 5A through 5C are schematic cross-sectional views of water treating devices 330a, 330b, and 330c according to embodiments of the present inventive concept. Components of the water treating devices 330a, 330b, and 330c respectively illustrated in FIGS. 5A, 5B, and 5C may be similar to corresponding components of the water treating device 330 described with reference to FIG. 2, and thus, differences thereof are described.

Referring to FIG. 5A, the water treating device 330a may include the storage tank 331, the pump 332, the first filter 333, the second filter 334, a first phosphorus removing device 335a, a second phosphorus removing device 335b, the ultraviolet ray irradiation device 336, and the supply tank 337.

In an embodiment, each of the first phosphorus removing device 335a and the second phosphorus removing device 335b may include a phosphorus absorbent, an ion exchange resin, an electrodialysis device, an electrodeionization device, or a combination thereof. For example, the first phosphorus removing device 335a may include the phosphorus absorbent, and the second phosphorus removing device 335b may include the ion exchange resin.

In an embodiment, the first phosphorus removing device 335a and the second phosphorus removing device 335b may be disposed at the rear end of the second filter 334. For example, the first phosphorus removing device 335a and the second phosphorus removing device 335b may be disposed between the rear end of the second filter 334 and the front end of the ultraviolet ray irradiation device 336. In an embodiment, the first phosphorus removing device 335a and the second phosphorus removing device 335b may be disposed at the rear end of the ultraviolet ray irradiation device 336. In an embodiment, the second filter 334 might not be included in the water treating device 330a, the first phosphorus removing device 335a and the second phosphorus removing device 335b may be at the rear end of the first filter 333.

For example, FIG. 5A illustrates that the water treating device 330a includes two phosphorus removing devices (e.g., first phosphorus removing device 335a and second phosphorus removing device 335b), but the embodiment is not limited thereto. For example, the water treating device 330a may include three or more phosphorus removing devices, and each of the three or more phosphorus removing devices may include the phosphorus absorbent, the ion exchange resin, the electrodialysis device, the electrodeionization device, or a combination thereof. In some cases, the three or more phosphorus removing devices may be disposed at the rear end of the second filter 334.

According to an embodiment, the water treating device 330a may include a plurality of phosphorus removing devices, and may remove phosphorus in the circulating water RW. Accordingly, generation of the microbial layer in the spray device (e.g., spray device 310 in FIG. 1) and the removing device (e.g., removing device 320 in FIG. 1) may be prevented.

Referring to FIG. 5B, the water treating device 330b may include the storage tank 331, the pump 332, the first filter 333, the second filter 334, a first phosphorus removing device 335c, a second phosphorus removing device 335d, the ultraviolet ray irradiation device 336, and the supply tank 337.

In an embodiment, the first phosphorus removing device 335c may be disposed at the front end of the first filter 333. For example, the first phosphorus removing device 335c may be disposed between the rear end of the pump 332 and the front end of the first filter 333. In an embodiment, the first phosphorus removing device 335c may be disposed between the rear end of the storage tank 331 and the front end of the pump 332.

In an embodiment, the second phosphorus removing device 335d may be disposed at the rear end of the second filter 334. For example, the second phosphorus removing device 335d may be disposed between the rear end of the second filter 334 and the front end of the ultraviolet ray irradiation device 336. In an embodiment, the second phosphorus removing device 335d may be disposed at the rear end of the ultraviolet ray irradiation device 336. In an embodiment, the second filter 334 might not be included, the second phosphorus removing device 335d may be disposed at the rear end of the first filter 333.

In an embodiment, the first phosphorus removing device 335c may include the electrodialysis device, electrodeionization device, or a combination thereof. For example, the first phosphorus removing device 335c may include an electrodeionization device. According to embodiments of the present inventive concept, when the first phosphorus removing device 335c includes one of the phosphorus absorbent or the ion exchange resin, a pressure load may be generated as phosphorus in the circulating water RW is removed by absorption or ion exchange. Then, the circulating water RW filtering by the first filter 333 and the second filter 334 at the rear end of the first phosphorus removing device 335c is affected.

In some embodiments, the second phosphorus removing device 335d may include the phosphorus absorbent, an ion exchange resin, an electrodialysis device, an electrodeionization device, or a combination thereof. For example, the second phosphorus removing device 335d may include the ion exchange resin.

For example, FIG. 5B illustrates that the water treating device 330b includes two phosphorus removing devices (e.g., first phosphorus removing device 335c and second phosphorus removing device 335d), but the embodiment is not limited thereto. For example, the water treating device 330b may include three or more phosphorus removing devices, some of the three or more phosphorus removing devices may be disposed at the front end of the first filter 333, and remaining ones of the three or more phosphorus removing devices may be disposed at the rear end of the second filter 334. In some cases, some of the three or more phosphorus removing devices may include at least one of an electrodialysis device or an electrodeionization device, and the remaining ones of the three or more phosphorus removing devices may include a phosphorus adsorbent, an ion exchange resin, an electrodialysis device, an electrodeionization device, or a combination thereof. For example, a plurality of first phosphorus removing devices disposed between the pump 332 and the first filter 333 may include an electrodialysis device and/or an electrodeionization device, and a plurality of second phosphorus removing devices disposed between second filter 334 and ultraviolet ray irradiation device 336 may include a phosphorus adsorbent, an ion exchange resin, an electrodialysis device, an electrodeionization device, or a combination thereof.

According to some embodiments, the water treating device 330b may include a plurality of phosphorus removing devices, and may remove phosphorus in the circulating water RW. Accordingly, generation of the microbial layer in the spray device (e.g., spray device 310 in FIG. 1) and the removing device (e.g., removing device 320 in FIG. 1) may be prevented.

Referring to FIG. 5C, the water treating device 330c may include the storage tank 331, the pump 332, the first filter 333, the second filter 334, a first phosphorus removing device 335e, a second phosphorus removing device 335f, the ultraviolet ray irradiation device 336, and the supply tank 337.

In an embodiment, each of the first phosphorus removing device 335e and the second phosphorus removing device 335f may be disposed at the front end of the first filter 333. For example, the first phosphorus removing device 335e and the second phosphorus removing device 335f may be disposed between the rear end of the pump 332 and the front end of the first filter 333. In an embodiment, the first phosphorus removing device 335e and the second phosphorus removing device 335f may be disposed between the rear end of the storage tank 331 and the front end of the pump 332.

In an embodiment, the first phosphorus removing device 335e may include at least one of an electrodialysis device or an electrodeionization device. For example, the first phosphorus removing device 335e may include an electrodeionization device, and the second phosphorus removing device 335f may include an electrodialysis device. According to embodiments of the present inventive concept, as described with reference to FIG. 5B, when the first phosphorus removing device 335e and the second phosphorus removing device 335f include one of the phosphorus absorbent or the ion exchange resin, a pressure load may be generated as phosphorus in the circulating water RW is removed by absorption or ion exchange. Then, the circulating water RW filtering by the first filter 333 and the second filter 334 at the rear end of the first phosphorus removing device 335c is affected.

For example, FIG. 5C illustrates that the water treating device 330c includes two phosphorus removing devices (e.g., first phosphorus removing device 335e and second phosphorus removing device 335f), but the embodiment is not limited thereto. For example, the water treating device 330c may include three or more phosphorus removing devices, and the three or more phosphorus removing devices may be disposed at the front end of the first filter 333. In some cases, each of the three or more phosphorus removing devices may include at least one of an electrodialysis device or an electrodeionization device.

According to embodiments of the present inventive concept, the water treating device 330c may include a plurality of phosphorus removing devices, where phosphorus in the circulating water RW are removed. Accordingly, generation of a microbial layer in the spray device (e.g., spray device 310 in FIG. 1) and the removing device (e.g., removing device 320 in FIG. 1) may be prevented.

While the inventive concept has been particularly shown and described with reference to embodiments thereof, it will be understood that various changes in form and details may be made therein without departing from the spirit and scope of the following claims.

What is claimed is:

1. A water treating device for treating a circulating water, the water treating device comprising:
a storage tank configured to store the circulating water;
a first filter configured to filter the circulating water discharged by the storage tank;
a phosphorus removing device configured to remove phosphorus contained in the circulating water; and
an ultraviolet ray irradiation device configured to irradiate an ultraviolet ray to the circulating water.

2. The water treating device of claim 1, wherein the phosphorus removing device comprises at least one of a phosphorus absorbent, an ion exchange resin, an electrodialysis device, or an electrodeionization (EDI) device.

3. The water treating device of claim 1, wherein the phosphorus removing device is downstream of the first filter.

4. The water treating device of claim 1, wherein the phosphorus removing device is configured to reduce a concentration of the phosphorus contained in the circulating water to less than or equal to 2 μg/L.

5. The water treating device of claim 1, further comprising:
a plurality of phosphorus removing devices, wherein each of the plurality of phosphorus removing devices comprises at least one of a phosphorus absorbent, an ion exchange resin, an electrodialysis device, or an electrodeionization (EDI) device.

6. The water treating device of claim 5, wherein the plurality of phosphorus removing devices comprise at least one of a phosphorus adsorbent or the ion exchange resin, and
wherein the plurality of phosphorus removing devices is downstream of the first filter.

7. The water treating device of claim 5, wherein some of the plurality of phosphorus removing devices are disposed at a front end of the first filter, some others of the plurality of phosphorus removing devices are downstream of the first filter, and some of the plurality of phosphorus removing devices at the front end of the first filter comprise at least one of the electrodialysis device or the EDI device.

8. The water treating device of claim 1, further comprising:
a second filter downstream of the first filter, wherein a pore diameter of the second filter ranges from about 0.1 μm to about 2 μm.

9. The water treating device of claim 8, wherein the phosphorus removing device is downstream of the second filter.

10. A wet cleaning device comprising:
a spray device configured to spray a process water into air;
a removing device configured to drop the process water and a circulating water containing contaminants collected by the process water; and
a water treating device configured to treat the circulating water to obtain a treated process water, and to supply the treated process water to the spray device,
wherein the water treating device comprises:
a storage tank configured to store the circulating water;
a first filter configured to filter the circulating water discharged by the storage tank;
a phosphorus removing device configured to remove phosphorus contained in the circulating water; and
an ultraviolet ray irradiation device configured to irradiate an ultraviolet ray to the circulating water.

11. The wet cleaning device of claim 10, wherein the spray device comprises one or more nozzles.

12. The wet cleaning device of claim 10, wherein the water treating device further comprises a sensor configured to measure a concentration of the phosphorus contained in the circulating water.

13. The wet cleaning device of claim 10, wherein the phosphorus removing device comprises at least one of a phosphorus absorbent, an ion exchange resin, an electrodialysis device, or an electrodeionization (EDI) device.

14. The wet cleaning device of claim 10, wherein the phosphorus removing device is disposed between a rear end of the first filter and a front end of the ultraviolet ray irradiation device.

15. The wet cleaning device of claim 10, further comprising:
a plurality of phosphorus removing devices, wherein each of the plurality of phosphorus removing devices comprises at least one of a phosphorus absorbent, an ion exchange resin, an electrodialysis device, or an electrodeionization (EDI) device.

16. The wet cleaning device of claim 10, wherein the water treating device further comprises a second filter downstream of the first filter, and
wherein a pore diameter of the second filter ranges from about 0.1 μm to about 2 μm.

17. The wet cleaning device of claim 16, wherein the phosphorus removing device is downstream of the second filter.

18. A water treating device for treating circulating water, the water treating device comprising:
a storage tank configured to store a first circulating water;
a supply tank configured to supply a supplementing water to the storage tank;
a first filter configured to filter the first circulating water and a second circulating water, wherein the second circulating water includes the supplementing water;
a phosphorus removing device configured to remove phosphorus contained in the second circulating water; and
an ultraviolet ray irradiation device configured to irradiate an ultraviolet ray to the second circulating water,
wherein the phosphorus removing device comprises at least one of a phosphorus absorbent, an ion exchange resin, an electrodialysis device, or an electrodeionization (EDI) device.

19. The water treating device of claim 18, further comprising:
a second filter disposed between a rear end of the first filter and a front end of the ultraviolet ray irradiation device, wherein a pore diameter of the second filter ranges from about 0.1 μm to about 2 μm.

20. The water treating device of claim 18, further comprising:
a plurality of phosphorus removing devices, wherein each of the plurality of phosphorus removing devices comprises at least one of the phosphorus absorbent, the ion exchange resin, the electrodialysis device, or the EDI device.
